(19) United States
(12) Patent Application Publication
(10) Pub. No.: US 2017/0301283 A1
(43) Pub. Date: Oct. 19, 2017

(54) DISPLAY APPARATUS

(71) Applicant: Innolux Corporation, Miao-Li County (TW)

(72) Inventors: Tung-Kai LIU, Miao-Li County (TW); Tsau-Hua HSIEH, Miao-Li County (TW); Bo-Feng CHEN, Miao-Li County (TW)

(73) Assignee: Innolux Corporation, Miao-Li County (TW)

(21) Appl. No.: 15/485,578

(22) Filed: Apr. 12, 2017

(30) Foreign Application Priority Data
Apr. 13, 2016 (CN) 201610227317.8

(51) Int. Cl. G09G 3/32

(52) U.S. Cl. CPC G09G 3/32; G09G 2370/18; G09G 2310/08; G09G 2320/0295

(57) ABSTRACT

An LED display apparatus, wherein the LED display apparatus includes a substrate having a first active area, a first LED element disposed in the first active area and a driving circuit electrically connects to the first LED element to drive the first LED element generating a continuous pulsed light having a first wave length range within a displaying time interval, wherein the first continuous pulsed light has a plurality of first light intensities and a plurality of second light intensities. The plurality of first light intensities are respectively corresponding to a first holding time interval and the plurality of second light intensities are corresponding to s a second holding time interval, at least one of the plurality of second light intensities is greater than at least one of the plurality of first light intensities, and the second holding time interval is less than the first holding time interval.

This application claims the benefit of People's Republic of China application Serial No. 201610227317.8, filed Apr. 13, 2016, the disclosure of which is incorporated by reference herein in its entirety.

### BACKGROUND OF THE INVENTION

### Field of the Invention

The disclosure relates in general to a display apparatus and applications thereof, and more particularly to a light emitting diode (LED) display apparatus and applications thereof.

### Description of the Related Art

Along with the development of in the consumer electronics domain, interactive display apparatuses have found widespread use in the consumer electronics. Recently, an interactive display apparatus is typically designed to have a sensing unit separated from a display unit. For example, the sensing unit may be configured on a peripheral area of the interactive display apparatus separated from the display unit used to receive light pulse from an external device and convert the light pulse into electric signals.

However, the sensing units that are disposed on the peripheral area of the interactive display apparatus may occupy some area originally used for sustaining the display unit, and it may deteriorate the image properties of the interactive display apparatus.

Therefore, it has become a prominent task for the industries to provide an advanced display apparatus and applications thereof to obviate the drawbacks encountered in the prior art.

### SUMMARY OF THE INVENTION

One embodiment of the description is directed to an LED display apparatus, wherein the LED display apparatus includes a substrate, a first LED element and a driving circuit. The substrate has a first active area, and the first LED element is disposed in the first active area. The driving circuit electrically connects to the first LED element to drive the first LED element generating a continuous pulsed light having a first wave length range within a displaying time interval, wherein the first continuous pulsed light has a plurality of first light intensities and a plurality of second light intensities. The plurality of first light intensities are corresponding to a first holding time interval and the plurality of second light intensities are corresponding to a second holding time interval, at least one of the plurality of second light intensities is greater than at least one of the plurality of first light intensities, and the second holding time interval is less than the first holding time interval.

In accordance with the embodiments of the present disclosure, an LED display apparatus including a substrate, at least one LED element and a driving circuit is disclosed. The driving circuit can apply a plurality bias voltages to the LED element within a displaying time interval, so as to control the current passing through the LED element and to drive the LED element generating a continuous pulsed light having a particular wave length range and two different light intensities, wherein the portion of the continuous pulsed light having lower light intensity may have a longer holding time interval and can be used to display image; and the other portion of the continuous pulsed light having higher light intensity may have a shorter holding time interval and can be converted into an aperiodic square wave for outputting flash signals. In addition, the LED display apparatus may further includes a sensing circuit electrically connected to the LED element to drive the LED element receiving light signals having particular wave length provided from an external device simultaneously, whereby a LED display apparatus having multiple functions that can display image, receive signals and output data within a frame period can be obtained, and the LED display apparatus can communicate with the external device without reducing its aperture ratio.

### BRIEF DESCRIPTION OF THE DRAWINGS

The above and other aspects of the disclosure will become better understood with regard to the following detailed description of the preferred but non-limiting embodiment(s). The following description is made with reference to the accompanying drawings.

FIG. 1 is a schematic diagram illustrating the circuit layout of an display apparatus in accordance with one embodiment of the present disclosure;

FIG. 2 is a cross-sectional view illustrating a pixel of the display apparatus in accordance with one embodiment of the present disclosure;

FIG. 3 illustrates a timing diagram of the LED elements of the display apparatus in accordance with one embodiment of the present disclosure;

FIG. 4A illustrate a flash image outputted by the display apparatus at a certain time point in accordance with one embodiment of the present disclosure;

FIG. 4B is a bitmap converted from the flash image depicted in FIG. 4A;

FIG. 5 is a schematic diagram illustrating the circuit layout of an display apparatus in accordance with one embodiment of the present disclosure;

FIG. 6 is a schematic diagram illustrating the circuit layout of the sensing circuit in accordance with one embodiment of the present disclosure;

FIG. 7 is a timing diagram illustrating the light pulses of the LED element while the display apparatus is operated under the image-displaying mode and the sensing mode in accordance with one embodiment of the present disclosure;

FIG. 8 is a schematic diagram illustrating an optical communication system in accordance with one embodiment of the present disclosure;

FIG. 9A is a schematic diagram illustrating an optical communication system in accordance with another embodiment of the present disclosure;

FIG. 9B is a schematic diagram illustrating an optical communication system in accordance with another embodiment of the present disclosure; and

FIG. 10 is a schematic diagram illustrating an optical communication system in accordance with yet another embodiment of the present disclosure.

### DETAILED DESCRIPTION OF THE INVENTION

The embodiments of the present disclosure provide an improved display apparatus and applications thereof to communicate the external device without reducing its displaying area and aperture ratio. To make the objects, technical features and advantages of the invention more apparent and easily understood, a number of exemplary embodiments are exemplified below with accompanying drawings.

It should be noted that the implementations and methods disclosed in the present disclosure are not for limiting the disclosure. The disclosure still can be implemented by using other features, elements methods and parameters. Exemplary embodiments are provided for illustrating the technical features of the disclosure, not for limiting the scope of protection of the disclosure. Any persons ordinarily skilled in the art can make suitable modifications and adjustments based on the description of the specification without breaching the spirit of the invention. Common reference designations are used throughout the drawings and embodiments to indicate the same elements.

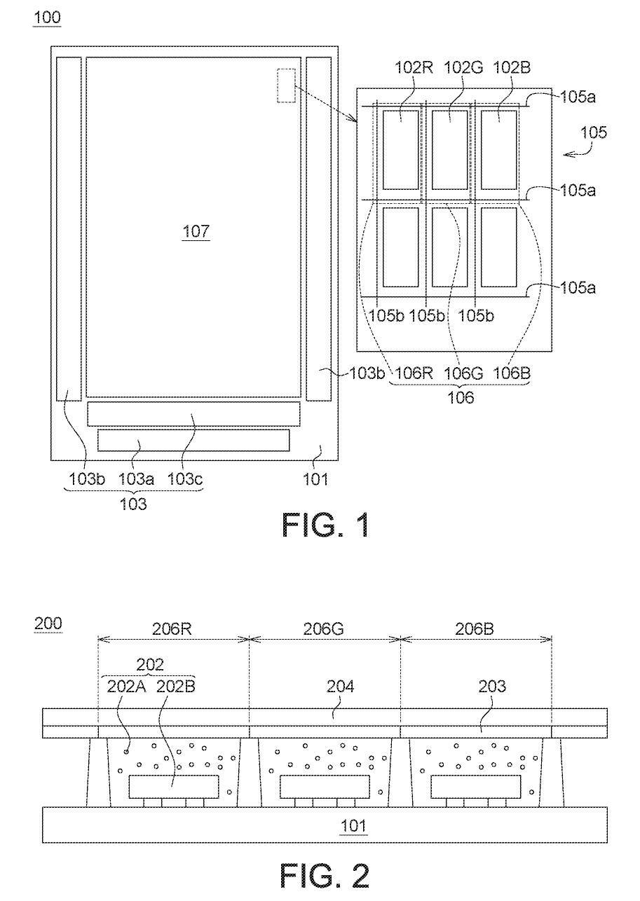

FIG. 1 is a schematic diagram illustrating a light emitting diode (LED) display apparatus 100 in accordance with one embodiment of the present disclosure. The LED display apparatus 100 includes a substrate 101, an active area 107, a plurality of LED elements formed on the active area 107 and a driving circuit 103, wherein the active area 107 not only can display images but also have optical communication functions. The light emitting diode (LED) could be an inorganic light emitting diode or an organic light emitting diode (OLED). The LED could be chip type (inorganic LED) or thin film structure type (OLED). The feature size (e.g., dimension, maximum width) of the chip type inorganic LED (effective diode region, a LED unit) is ranged from 0.1 um to 100 um, preferably ranges from 1 μm to 50 μm, and which is called micro-size LED (micro LED or μ LED).

In some embodiments of the present disclosure, the substrate 101 can be a glass substrate, a semiconductor substrate, a metal substrate or a plastic substrate. The substrate 101 may have flexibility. In the embodiment, the substrate 101 is a glass substrate used to carry a thin film transistor (TFT) array 105, conductive wires and the LED elements array. The LED elements are disposed in the TFT array 105 and driven by the TFT array 105 used for displaying images and conducting optical communications. The LED elements have a pitch ranging from 0.1 μm to 1000 μm, preferably ranges from 1 μm to 100 μm. The pitch of the micro LED elements is the distance between the repeat structures of two adjacent ones of the micro LED elements. For example, the pitch can be the distance between opposite sides or corners of the two adjacent micro LED elements.

The TFT array 105 is constituted by a patterned metal layer and a plurality of TFTs formed on the substrate 101, wherein the patterned metal layer includes a plurality of scan lines 105a and data lines 105b electrically connected to the TFTs respectively. The semiconductor layer of TFTs may include a material such as amorphous silicon (a-Si), low temperature poly-silicon (LTPS), indium gallium zinc oxide (IGZO), other kinds of silicon base semiconductor, or other kinds of oxide semiconductor. The scan lines 105a and the data lines 105b are electrically isolated and may intersect with each other either vertically or to form non-right angles, whereby at least one sub-pixel 106 can be defined between two adjacent ones of the scan lines 105a and two adjacent ones of the data lines 105b. Each sub-pixel 106 has at least one TFT (not shown) disposed therein and electrically connected to corresponding of the scan lines 105a and corresponding of the data lines 105b. Each of the sub-pixel, respectively designated as 106R, 106G and 106B according to its color, has at least one LED electrically connected to one of the scan lines 105a and one of the data lines 105b through at least one active device (like TFT, not shown) to form an LED element 102R, 102G or 102B. A plurality of the LED elements 102R, 102G and 102B can constitute a pixel 106; and a plurality of the pixels 106 arranged in an array can constitute the active area 107.

In some embodiments of the present disclosure, each pixel 106 has three sub-pixels 106R, 106G and 106B respectively constituted by the LED elements 102R, 102G and 102B that can emit different colors (with different spectrum).

For example, the LED element 102B may include an LED chip made of indium gallium nitride (InGaN) that can emit a blue light with a wave length range ranging from 450 nm to 495 nm; the LED element 102R may include an LED chip made of gallium arsenide phosphide (GaAsP) or aluminum gallium arsenide (AlGaAs) that can emit a red light with a wave length range ranging from 630 nm to 780 nm; and the LED element 102G may include an LED chip made of gallium nitride (GaN) that can emit a green light with a wave length range ranging from 530 nm to 560 nm. However, it should be noted that the material and structure of the LED element 102R, 102G and 102B may not be limited to this regards.

FIG. 2 is a cross-sectional view illustrating a pixel 206 of the LED display apparatus 200 in accordance with another embodiment of the present disclosure. In the embodiment, each of the sub-pixels 206R, 206G and 206B of the LED display apparatus 200 includes at least one LED chip 202B emitting blue light (there in after referred to as blue LED chip 202B), coated by phosphor 202A and covered by a color filter layer 203 including a red sub-color filter (R), a green sub-color filter (G) and a blue sub-color filter (B). The phosphor 202A can be excited by the blue light provided from the blue LED chip 202B to produce fluorescent light, the blue light and the fluorescent light can be combined to produce a white light; and three light beams with different colors can be obtained while the white light passing through the color filter layer 203 and the cover glass 204. In some other embodiments of the present disclosure, other kinds of LED chips, LED thin film structures and phosphors may be applied to form the LED display apparatus and produce white light or light beams with other colors. In some embodiment, different colors LED chips or LCD thin film structures may be provided to directly produce light beams with different colors, and the color filter layer 203 may be omitted.

Referring to FIG. 1 again, the driving circuit 103 includes a timing controller 103a, a gate driving circuit 103b (single-sided or double-sided) and a data driving circuit 103c. The timing controller 103a that are electrically connected to the TFT array 105 of the active area 107 through the gate driving circuit 103b and the data driving circuit 103c is used to control the switch state of the TFTs of the pixels 106 for outputting image data to the LED elements 102R, 102G and 102B. In some embodiments of the present disclosure, the timing controller 103a, the gate driving circuit 103b and the data driving circuit 103c of the driving circuit 103 are disposed out of the active area 107 of the substrate 101 or integrated on an external integrated circuit (IC) which is disposed on an IC integration base board.

For example, the data driving circuit 103c may be a de-multiplexer (DEMUX) electrically connected to the LED elements 102R, 102G and 102B through corresponding data lines 105b to control the current volume passing through the LED display apparatus 100 serving as the image data. The gate driving circuit 103b may be a gate-on-panel (GOP) driving circuit electrically connected to the LED elements 102R, 102G and 102B through the corresponding ones of the scan line 105a to control the switch state of the active devices and the current volume passing through the LED display apparatus.

In some embodiments of the present disclosure, when the LED elements 102R, 102G and 102B are switched to an image-displaying mode, the TFTs of the LED elements 102R, 102G and 102B are turn on by the gate driving circuit 103b through the corresponding ones of the scan lines 105a to control the current volume passing through the LED display apparatus; and a plurality of bias voltages are applied to the LED elements 102R, 102G and 102B by the data driving circuit 103c through the corresponding ones of the data lines 105b to control the current volume passing through the LED display apparatus and the retaining time of the bias voltages, so as to make each of the LED elements 102R, 102G and 102B emitting a continuous pules light within an image displaying time interval T1.

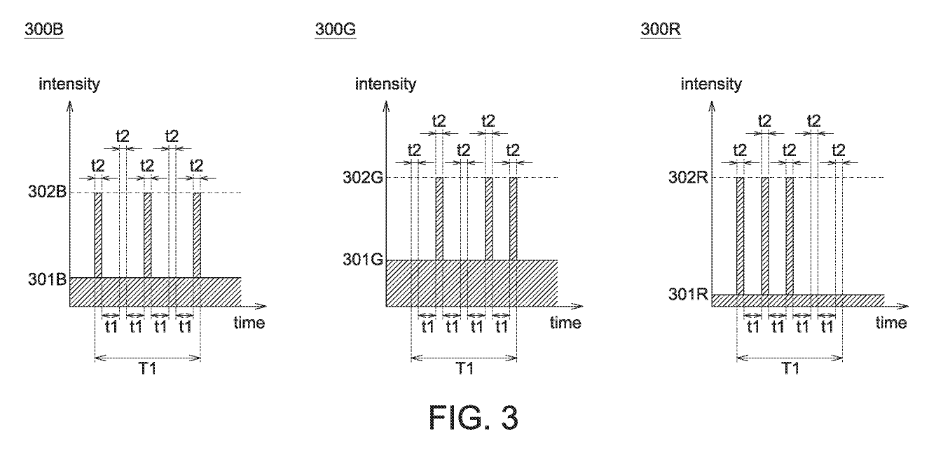

FIG. 3 illustrates a timing diagram of the LED elements 102R, 102G and 102B of the LED display apparatus 100 in accordance with one embodiment of the present disclosure. When the LED elements 102R, 102G and 102B are switched to the image-displaying mode, each of the LED elements 102R, 102G and 102B can emit a continuous pules light that can be converted into a aperiodic square wave 300R, 300G or 300B representing the relationship between the light intensity and time.

In the present embodiment, each of the aperiodic square wave 300R, 300G and 300B has two light intensities with amplitudes greater than 0. For example, the aperiodic square wave 300R has two light intensities 301R and 302R, wherein the amplitude of the light intensity 301R is less than that of the light intensity 302R; and the light intensity 302R has a holding time interval t2 less than a holding time interval t1 of the light intensity 301R. The aperiodic square wave 300G has two light intensities 301G and 302G, wherein the amplitude of the light intensity 301G is less than that of the light intensity 302G; the light intensity 302G has the holding time interval t2; and the light intensity 301G has the holding time interval t1. The aperiodic square wave 300B has two light intensities 301B and 302B, wherein the amplitude of the light intensity 301B is less than that of the light intensity 302G; the light intensity 302B has the holding time interval t2; and the light intensity 301B has the holding time interval t1. The time interval t2 substantially ranges from 0.1 microsecond (μs) to 100 μs, and preferably ranges from 0.1 μs to 10 μs.

Within the image displaying time interval T1, the portion of the aperiodic square waves 300R, 300G and 300B that have lower light intensity, such as the light intensities 301R, 301G and 301B, may have the longer holding time interval t1, and can be used to display images that can be recognized by human eyes. The data voltage used to produce the light intensities 301R, 301G and 301B may be less than that for producing the highest gray scale pulse and greater than that for producing the lowest gray scale pulse. The lowest data voltage used to produce the light intensities 301R, 301G and 301B is greater than a reference voltage (that can be a zero or a non-zero voltage); and the amplitudes of the light intensities 301R, 301G and 301B may be the identical to or different from each other. The other portion of the aperiodic square waves 300R, 300G and 300B that have higher light intensity, such as the light intensities 302R, 302G and 302B, may have the shorter holding time interval t2, and can be converted into an aperiodic square wave used to output flash signals. The data voltage used to produce the light intensity 302R, 302G and 302B may be less than that for producing the highest gray scale pulse and greater than that for producing the lowest gray scale pulse, or even greater than that for producing the highest gray scale pulse. The lowest data voltage used to produce the light intensities 302R, 302G and 302B is greater than a reference voltage (that can be a zero or a non-zero voltage), and the amplitudes of the light intensities 301R, 301G and 301B may be the identical to or different from each other. The difference between the portion of the aperiodic square wave 300R, 300G and 300B that have higher light intensity, such as the light intensities 302R, 302G and 302B, and the other portion of the aperiodic square waves 300R, 300G and 300B that have lower light intensity, such as the light intensity 301R, 301G and 301B, can be converted into binary codes. In other words, the flash signals outputted by the LED elements 102R, 102G and 102B can be converted into binary number system consist of only two digits, 0 and 1.

Table 1 illustrates the binary codes obtained by converting the flash signals of the aperiodic square waves 300R, 300G and 300B outputted by the LED elements 102R, 102G and 102B.

TABLE 1

| 102R | 102G | 102B |
|---|---|---|
| 1 | 0 | 1 |
| 1 | 1 | 0 |
| 1 | 0 | 1 |
| 0 | 1 | 0 |
| 0 | 1 | 1 |

In the present embodiment, each pixel 106 has three LED elements 102R, 102G and 102B, and the flash signals outputted by the LED elements 102R, 102G and 102B can be converted into binary numbers consist of only two digits, 0 and 1. In other words, per pixel 106 can output 2³ bites data. IF each of the LED elements 102R, 102G and 102B can blink 5 times within the image displaying time interval T1 (it means there are 5 holding time intervals t2 within the image displaying time interval T1), per pixel 106 can output 2³×2³×2³×2³×2³=32,768 bites data within the image displaying time interval T1. However, the number of the LED blink may not be limited to this regards, the LED elements 102R, 102G and 102B may blink one time or more than one time within the image displaying time interval T1.

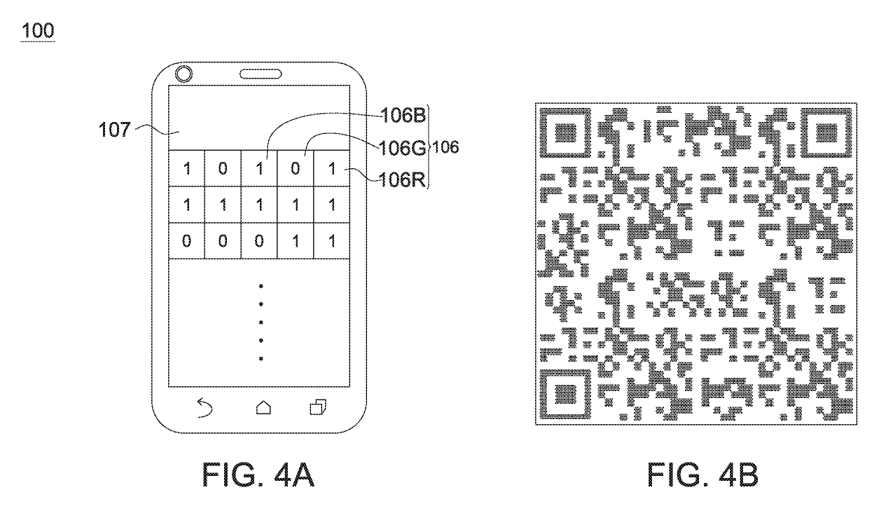

FIG. 4A illustrate a real time image of the LED display apparatus 100 at a certain time point in accordance with one embodiment of the present disclosure; and FIG. 4B is a bitmap converted from the flash image depicted in FIG. 4A. In some embodiments of the present disclosure, the bitmap may not be limited to this regards.

Signals can be outputted by the LED display apparatus 100 in terms of the flash images, as shown in FIG. 4A, and the spatial domain of the flash images can be converted into a bitmap, as shown in FIG. 4B. In the present embodiment, the active area 107 of the LED display apparatus 100 has 1024 pixels 106. Per bitmap outputted by the LED display apparatus 100 can contain 2¹⁰²⁴ bytes data. As the pixel number involved in the active area 107 is increased, the data volume contained in one bitmap can be also increased.

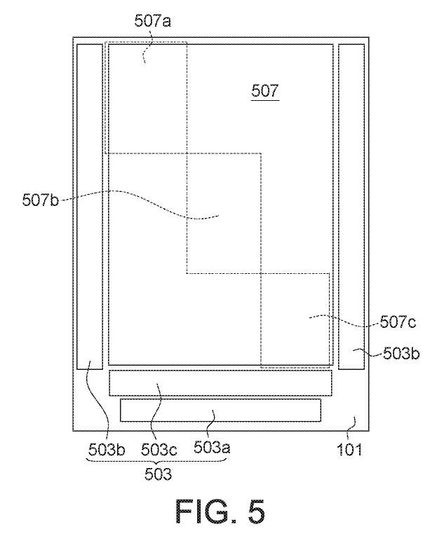

FIG. 5 is a schematic diagram illustrating the circuit layout of the LED display apparatus 500 in accordance with one embodiment of the present disclosure. The circuit layout of the LED display apparatus 500 is similar to the circuit layout of the LED display apparatus 100 depicted in FIG. 1, except that the active area 507 of the LED display apparatus 500 is divided into three sub-active area 507a, 507b and 507c. Three LED elements 102R, 102G and 102B that are respectively disposed on different ones of the sub-active area 507a, 507b and 507c can output three set of signals by the control of the driving circuit 503 including a timing controller 503a, a gate driving circuit 503b (single-sided or double-sided) and a data driving circuit 503c. Such that, the LED display apparatus 500 can exchange information with three different external devices simultaneously by optical communication. However, it should be appreciated that, the number of the sub-active area is not limited to 3. In some embodiments of the present disclosure, the number of the sub-active area may be 2 or more than 2, the number of the external devices communicating with the LED display apparatus 500 may be 2 or more than 2.

Referring to FIG. 1 and FIG. 5 again, the LED display apparatus 100 (or 500) may further include a sensing circuit 104. The sensing circuit 104 is electrically connected to the LED elements 102R, 102G and 102B through a sensing wire 108. Current or voltage variation can be detected by the sensing circuit 104 while the LED chips of the LED elements 102R, 102G and 102B are subjected to external light with different wave lengths. When the LED display apparatus is switched to a sensing mode, current and voltage signals may be generated respectively by the LED elements 102R, 102G and 102B corresponding to its color, and the signals then can be transmitted to a central process unit (CPU) (not shown) through the sensing wire 108 for performing subsequent treatment. The sensing circuit 104 can be electrically connected to the driving circuit 103 (503).

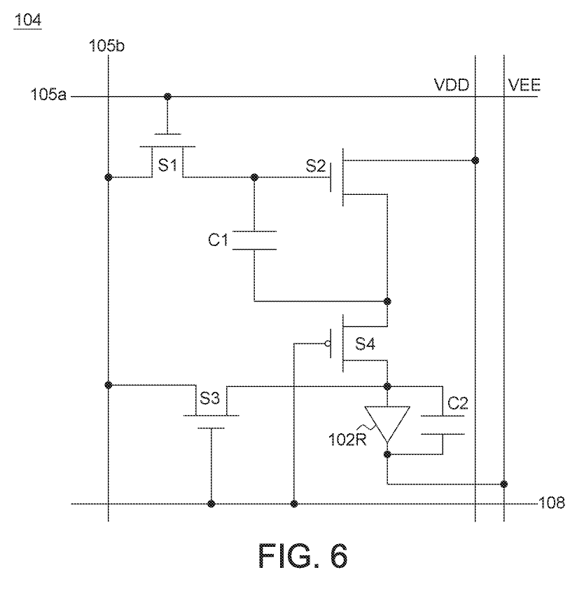

In some embodiments of the present disclosure, the sensing circuit 104 may be (but not limited to) integrated with the TFT array 105 of the LED display apparatus 100. FIG. 6 is a schematic diagram illustrating the layout of the sensing circuit 104 in accordance with one embodiment of the present disclosure. The sensing circuit 104 includes four TFT switches S1, S2, S3 and S4 and two capacitors C1 and C2, wherein the TFT switches S1, S2 and S3 are n-type metal-oxide-semiconductor (NMOS) transistors, and the TFT switch S4 is a p-type metal-oxide-semiconductor (PMOS) transistor. The gate electrode of the TFT switch S1 is connected to a scan line 105a of the TFT array 105; and the source electrodes of the TFT switches S1 and S3 are respectively connected to a data line 105b. The gate electrode of the TFT switch S2 is connected to a drain electrode of the TFT switch S1; and the source electrode is connected to a power source VDD. The two ends of the capacitor C1 are respectively connected to the gate electrode and the drain electrode of the TFT switch S2. The gate electrodes of the TFT switches S3 and S4 respectively connected to the sensing wire 108. The drain electrode of the TFT switch S4 is connected to the capacitor C1 and the drain electrode of the TFT switch S2. One end of the LED element 102R is connected to the drain electrode of the TFT switch S3, the source electrode of the TFT switch S4 and one end of the capacitor C2; and the other end of the LED element 102R is connected to the other end of the capacitor C2 to receive reference signals VEE.

When the LED display apparatus is switched to a transmission mode, the TFT switches S1 and S4 can be turn on, current passing through the data lines 105b can be saved in the capacitor C1, whereby the TFT switch S2 can be remained in the on-state to allow current coming from power source VDD flowing into the LED element 102R. When the LED display apparatus is switched to the sensing mode, the TFT switch S3 can be turn on, and the TFT switch S4 can be turn off, whereby the variation detected by the LED element 102R can be converted into current or voltage and then be saved in the capacitor C2. Subsequently, the signals saved in the capacitor C2 is transmitted to the CPU (not shown) electrically connected to the LED display apparatus 100 by turning off the TFT switch S3 and turning on the TFT switch S4 at the same time.

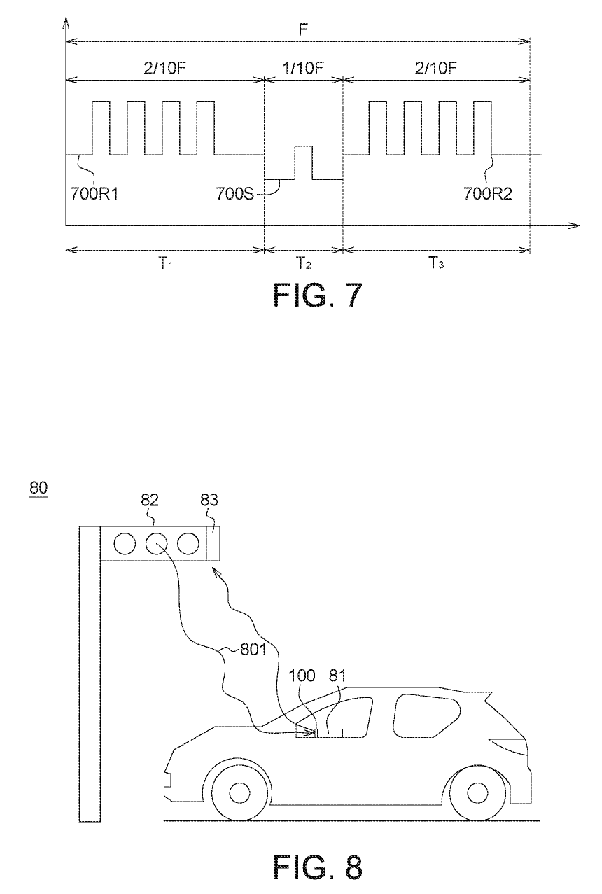

In some embodiments of the present disclosure, the procedures of the sensing mode of the LED display apparatus 100 can be performed between the procedures of two image-displaying modes. For example, FIG. 7 is a timing diagram illustrating the light pulses of the LED element 102R while the LED display apparatus 100 is operated under the image-displaying mode and the sensing mode in accordance with one embodiment of the present disclosure.

In the present embodiment, the LED display apparatus 100 may be switched to the image-displaying mode twice and switched to the sensing mode one time within a frame period F. The LED display apparatus 100 is firstly operated under the image-displaying mode for an image displaying time interval T1, then switched to the sensing mode holding for a sensing time interval T2, and finally switched to the image-displaying mode again holding for another image displaying time interval T3. As shown in FIG. 7, the relationship between the light intensity and time of the LED element 102R operated under these two image-displaying mode can be converted into the aperiodic square waves 700R1 and 700R2, and the relationship between the voltage variation and time of the LED element 102R operated under the sensing mode can be converted into the aperiodic square wave 700S. The image displaying time intervals T1 and T3 may be about 2/10 of the frame period F (T1 and T3= 2/10 F), and the sensing time interval T2 may be about 1/10 of the frame period F (T2= 1/10 F). In some embodiments, the process performed under the sensing mode within the sensing time interval T2 may be divided into several sensing steps, and the number and the time interval of the sensing steps can be controlled by the sensing wire 108.

The LED display apparatus 100, as discussed above, may be built within an electronics product and integrated with an external LED device to form an optical communication system. For example, FIG. 8 is a schematic diagram illustrating an optical communication system 80 in accordance with one embodiment of the present disclosure.

In the present embodiment, the LED display apparatus 100 is built within and in-vehicle navigation apparatus 81, wherein the navigation information can be displayed on a screen or projected on the windshield of the car by the LED display apparatus 100. The real traffic condition detected by the LED display apparatus 100 can be also displayed thereon. In addition, the traffic information provided from an external device, such as the traffic signals (of red, yellow or green color) provided by a traffic light 82, can be detected and further processed; and the processed traffic information can be display on the screen or the windshield. The flash signals 801 outputted by the LED display apparatus 100 can be received by an external detector 803 built in the traffic light 82 for the further treatments. In some embodiments of the present disclosure, information cascades can be created between the LED display apparatus 100 and a vehicle-mounted computer, whereby the information obtained from the optical communications can be transmitted to the vehicle-mounted computer to determine the external environmental condition, upon which decisions can be make to manipulate the trajectory or motions (running or stop) of the vehicle; and the relevant information can be provided to the driver by displaying the information on the screen and the windshield.

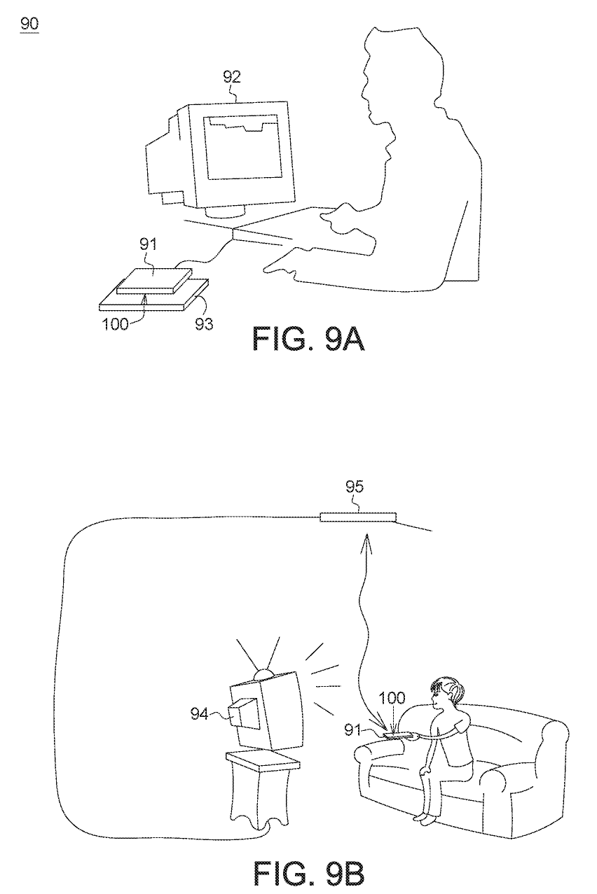

FIG. 9 is a schematic diagram illustrating an optical communication system 90 in accordance with another embodiment of the present disclosure. In the present embodiment, the LED display apparatus 100 is built within a portable electronic device, such as a cell phone 91. The cell phone 91 can communicate with an external signal transmission device 93, such as a card reader, built in a personal computer or a work station 92 through the LED display apparatus 100 to remotely manipulate the personal computer or a work station 92.

In addition, the cell phone 91 may serve as a remote control, as shown in FIG. 9B, that can communicate with an external signal transmission device 95 electrically connected to a television 94 to remotely control the television 94. Since the optical communication between the LED display apparatus 100 built in the cell phone 91 and the external signal transmission devices 93 and 95 merely can take place along a certain direction and within a certain distance, thus the optical communication can be kept secret and private. In some embodiments of the present disclosure, the cell phone 91 may serve as a remote control of other household appliances, such as microwave ovens, refrigerators, washing machines, dehumidifiers, air cleaners, air-conditioning, air switches, sweeping machines, mopping machine and so on.

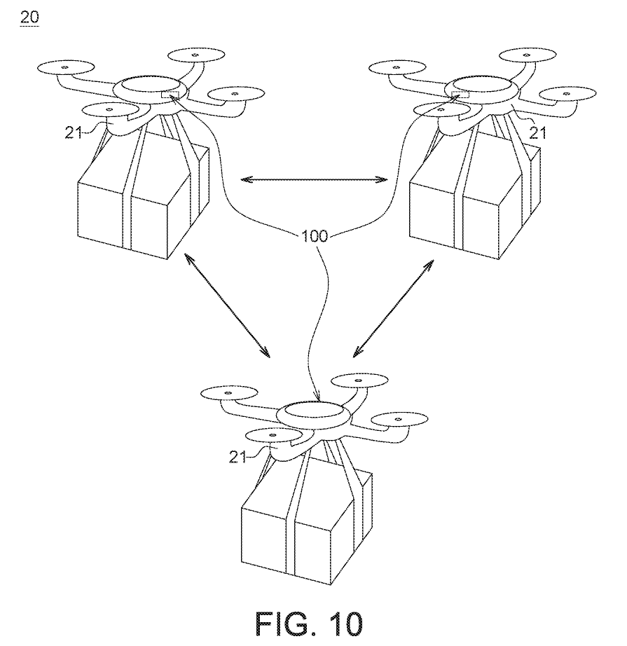

FIG. 10 is a schematic diagram illustrating an optical communication system 20 in accordance with yet another embodiment of the present disclosure. The LED display apparatus 100 is applied to an autopilot facility, such as a self-driving cars or an unmanned aerial vehicle (UAV) 21. Various UAVs 21 flying in the same airspace can communicate with each other by the built-in LED display apparatus 100 for implementing a mutual check on calculating their locations, so as to avoid collisions crashing.

In accordance with the embodiments of the present disclosure, an LED display apparatus including a substrate, at least one LED element and a driving circuit is disclosed. The driving circuit can apply a plurality bias voltages to the LED element within a displaying time interval, so as to control the current passing through the LED element and to drive the LED element generating a continuous pulsed light having a particular wave length and two different light intensities, wherein the portion of the continuous pulsed light having lower light intensity may have a longer holding time interval and can be used to display image; and the other portion of the continuous pulsed light having higher light intensity may have a shorter holding time interval and can be converted into an aperiodic square wave for outputting flash signals. In addition, the LED display apparatus may further includes a sensing circuit electrically connected to the LED element to drive the LED element receiving light signals having particular wave length provided from an external device simultaneously, whereby a LED display apparatus having multiple functions that can display image, receive signals and output data within a frame period can be obtained, and the LED display apparatus can communicate with the external device without reducing its aperture ratio.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light emitting diode (LED) display apparatus, comprising:
a substrate having a first active area;
a first LED element, disposed in the first active area; and
a driving circuit, electrically connected to the first LED element, wherein the driving circuit drives the first LED element to generate a first continuous pulsed light having a first wave length range within a first displaying time interval, the first continuous pulsed light has a plurality of first light intensities and a plurality of second light intensities, wherein the plurality of first light intensities are respectively corresponding to a first holding time interval, and the plurality of second light intensities are respectively corresponding to a second holding time interval,
wherein at least one of the plurality of second light intensities is greater than at least one of the plurality of first light intensities, and the second holding time interval is less than the first holding time interval.

2. The LED display apparatus according to claim 1, wherein the second holding time interval substantially ranges from 0.1 microsecond (μs) to 100 μs.

3. The LED display apparatus according to claim 1, further comprising a sensing circuit electrically connected to the first LED element, wherein the sensing circuit senses a first current or a first voltage of the first LED element resulted from receiving the first wave length range of a first external light within a first sensing time interval.

4. The LED display apparatus according to claim 3, further comprising a second LED element disposed in the first active area and electrically connected to the driving circuit, wherein the driving circuit drives the second LED element to generate a second continuous pulsed light having a second wave length range within the first displaying time interval, the second continuous pulsed light has a plurality of third light intensities and a plurality of fourth light intensities, the plurality of third light intensities are respectively corresponding to a third holding time interval, and the plurality of fourth light intensities are respectively corresponding to a fourth holding time interval, at least one of the plurality of fourth light intensities is greater than at least one of the plurality of third light intensities, and the fourth holding time interval is less than the third holding time interval.

5. The LED display apparatus according to claim 4, wherein the fourth holding time interval substantially ranges from 0.1 μs to 100 μs.

6. The LED display apparatus according to claim 4, wherein the sensing circuit electrically connected to the second LED element, the sensing circuit senses a second current or a second voltage of the second LED element resulted from receiving the second wave length range of the first external light within the first sensing time interval.

7. The LED display apparatus according to claim 3, wherein the first displaying time interval is greater than the first sensing time interval.

8. The LED display apparatus according to claim 4, further comprising:
a second active area, disposed on the substrate;
a third LED element disposed in the second active area; and
a fourth LED element disposed in the second active area; wherein the driving circuit electrically connects to the third LED element and the fourth LED element, the driving circuit drives the third LED element to generate a third continuous pulsed light having the first wave length range, the driving circuit drives the fourth LED element to generate a fourth continuous pulsed light having the second wave length range within the first displaying time interval, the third continuous pulsed light has a plurality of fifth light intensities and a plurality of sixth light intensities, the plurality of fifth light intensities are respectively corresponding to a fifth holding time interval, and the plurality of sixth light intensities are respectively corresponding to a sixth holding time interval, the fourth continuous pulsed light has a plurality of seventh light intensities and a plurality of eighth light intensities, the plurality of seventh light intensities are respectively corresponding to the seventh holding time interval, and the plurality of eighth light intensities are respectively corresponding to a eighth holding time interval, at least one of the plurality of sixth light intensities is greater than at least one of the plurality of fifth light intensities, the sixth holding time interval is less than the fifth holding time interval, at least one of the plurality of eighth light intensities is greater than at least one of the plurality of seventh light intensities, and the eight holding time interval is greater than the seventh holding time interval.

9. The LED display apparatus according to claim 8, wherein the sensing circuit senses a third current or a third voltage of the third LED element resulted from receiving a second external light having the first wave length range, and a fourth current or a fourth voltage of the fourth LED element resulted from receiving the second external light having the second wave length range.

10. The LED display apparatus according to claim 9, further comprising an external light emitting apparatus to provide the first external light, the second external light or the combination thereof.
